(19) United States
(12) Patent Application Publication
(10) Pub. No.: US 2020/0034911 A1
(43) Pub. Date: Jan. 30, 2020

(54) Ensemble Generation System for Retail Marketing

(71) Applicant: Mad Street Den, Inc., Redwood City, CA (US)

(72) Inventors: Janani Sriram, Bangalore (IN); Simrat Hanspal, Bangalore (IN); Sandhya Varatharajan, Bangalore (IN); Niranjan Mujumdar, Chennai (IN); Anand Chandrasekaran, Chennai (IN)

(21) Appl. No.: 16/523,260

(22) Filed: Jul. 26, 2019

Related U.S. Application Data
(60) Provisional application No. 62/711,208, filed on Jul. 27, 2018.

(51) Int. Cl. G06Q 30/06

(52) U.S. Cl. CPC G06Q 30/0631

(57) ABSTRACT

A method for presenting related products to a user includes providing product association data derived at least partially from at least one of traffic-based links and expert curated links. A product ensemble can be generated from the product association data. The generated product ensembles can be scored for compatibility and highly scored ensembles recommended to a user.

### CROSS-REFERENCE TO RELATED APPLICATIONS

This application claims priority to U.S. Provisional Patent Application Ser. No. 62/711,208, filed Jul. 27, 2018 titled “Ensemble Generation System for Retail Marketing,” which is incorporated herein by reference in its entirety, including but not limited to those portions that specifically appear hereinafter, the incorporation by reference being made with the following exception: In the event that any portion of the above-referenced application is inconsistent with this application, this application supersedes the above-referenced application.

### FIELD OF THE INVENTION

This invention relates generally to a system capable of providing consumer relevant product recommendations or choices. Visual data, traffic patterns, and product metadata attributes can be used to products suitable for presentation to a potential buyer.

### BACKGROUND

Expert or friendly opinions on suitability of colors and styles of clothing or other products have long been sought. Such opinions can include noting suitable products to purchase or finding visually coordinated ensembles of products in fashion and furniture. Factual questions related to positioning of articles, styling, or wear tips are also appreciated. Store owners or retailers appreciate favorable opinions, since they encourage consumer purchase and increase Average Order Value (AoV) and repeat buys.

Aspects of this experience can be emulated on e-commerce websites. When a user buys an item from an e-commerce website, an effective cross-sell engine can find other complementary products that pair well with the purchased one. Typical strategies use techniques like market basket analysis to identify ‘frequently bought together’ items. Unfortunately, this purely data-driven approach is subject to noisiness due to ‘mixed intent’—where users buy groups of items that do not logically pair well together. For instance, people may purchase quality clothing for an adult fashion ensemble along with outdoor work clothes in a single purchase basket, leaving the decision to buy a matching fashionable items at a later time. Such decisions can make identifying logically connected items using just clickstream data is problematic and error-prone.

Traffic based cross-sell recommendations have been used in conjunction with explicit denoising techniques to identify items that can be paired with each other. Unfortunately, this requires a large amount traffic data and a lengthy transaction history in order to identify commercially useful purchase patterns. Alternatively, manual or semi-automated curation or ensemble generation have been tried. Noted expert stylists can identify product pairing in a manual curation process, standardized ‘shop the look’ or ‘shop the room’ web pages can be created as a starting point, or machine classifiers can be defined to use metadata, labelled data, or other mechanism for determining useful pairings and/or relationships.

### SUMMARY

In one described embodiment, a method for presenting related products to a user includes providing product association data derived at least partially from at least one of traffic-based links and expert curated links. A product ensemble can be generated from the product association data. The generated product ensembles can be scored for compatibility and highly scored ensembles recommended to a user.

In another embodiment a system for presenting related products to a user includes a product association module able to provide data derived at least partially from at least one of traffic-based links and expert curated links and determine a product ensemble from the product association data. The system also has a compatibility scoring module able to determine compatibility scores from the generated product ensembles of the product association module. A recommendation module is used for recommending highly scored ensembles to a user based on the determined compatibility scores.

Various compatibility measures for both the described method and system can be used, including those based on either/both visual or non-visual compatibility measures. Compatibility scoring can based at least in part on pointwise mutual information techniques, color compatibility, pattern compatibility, category compatibility, style compatibility, occasion compatibility, brand compatibility, price compatibility, or a personalized scoring boost based on user data.

### BRIEF DESCRIPTION OF THE DRAWINGS

The specific features, aspects and advantages of the present invention will become better understood with regard to the following description and accompanying drawings where:

FIG. 1 illustrates a cloud-based system for cross-sell recommendations; and

FIG. 2 illustrates a cross-sell recommendation system that uses visual and non-visual compatibility, along with personalization, as an aid to compatibility scoring.

### DETAILED DESCRIPTION

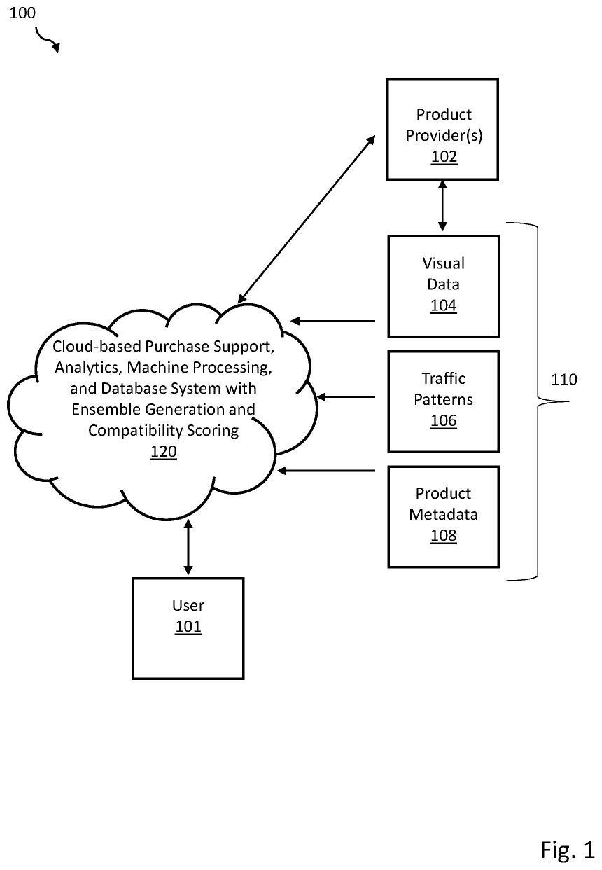

FIG. 1 illustrates recommendation system 100 that can provide a consumer or user 101 with high quality recommendations for related products and/or services. A product provider 102, which can include retailers, wholesalers, e-commerce sites, or the like, can provide or permit access to product and sales data 110. This data can include, but is not limited to, visual data concerning a product 104, traffic patterns 106 of search or sale, and product metadata 108. This information can be used by a cloud-based system 120 that it some embodiments can provide purchase support, analytics, machine learning systems and processing, a database system, along with an ability to create a recommendation of one or more related products or services to a user. This recommendation is based at least in part by a created product/service ensemble modified by a compatibility scoring scheme.

In some embodiments, the cloud-based system 120 can use data 110 to provide scores for compatible products that can be part of retail ensembles (i.e. a set of product types that can be logically paired with each other). For example, an ensemble of fashion outfits and accessories is comprised of individual items specifically designed, or fortuitously styled, in a manner that allows them to be worn together. A fashion ensemble could include formal shirts with trousers and pumps. Other examples can be furniture ensembles that include furniture items that can be positioned together harmoniously in a room, kitchenware ensembles of dipping bowls, placemats and napkins.

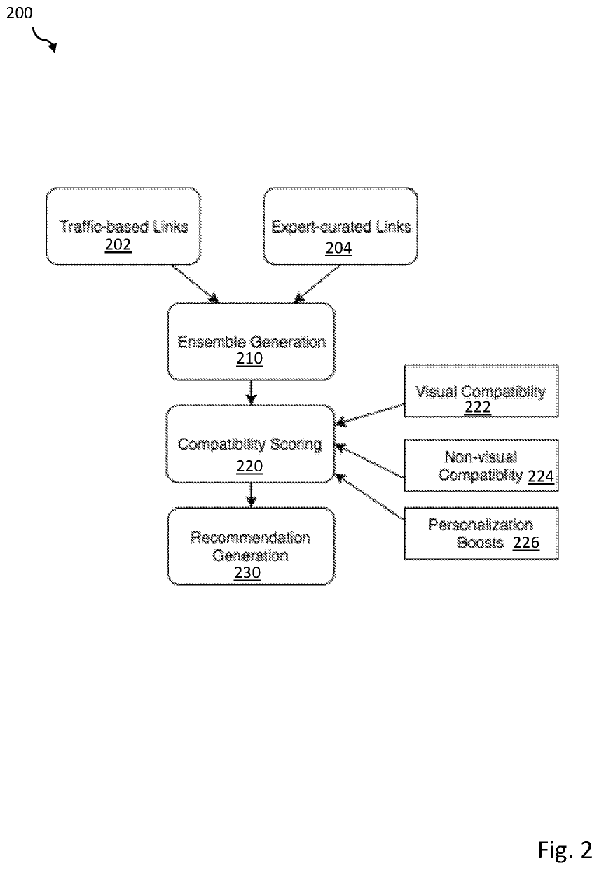

As seen with respect to schema 200 of FIG. 2, procedures for generating potential ensembles can use, but are not limited to, human curated links 204 and interesting associations mined from traffic patterns 202. Combining these associations together allows formation of a matrix of co-occurrence links between product types. Strongly connected ensembles of product types are extracted by walking through these links and building groups of products ranked by their scores. As will be understood, other ensemble generation inputs can be used in addition, or instead of, traffic or expert-curated links. Such inputs can include, for example, outfit lookbooks or preset bundles.

Generated ensembles 210 can be scored for compatibility 220 based on a set of scores based on features such as primary visual signals 222 extracted from the image, including color and pattern of the item. Other scored characteristics can include non-visual signals 224 such as touch characteristics, deformability characteristics, smell, or material construction. User provided personalization score boosts 226 can also be used, with user provided preferences in color, brands, or prices being input to the compatibility scoring module 220. Higher level features such as style and occasion (e.g. a holiday related product) can also be extracted using machine classifiers trained on visual data and the textual metadata attributes of the product. Commercial metadata signals such as brand and price can also be used. Based on scoring of a number of potential ensembles, one or more ensembles are selected and presented for review and possible purchase by a consumer or user.

In effect, a comprehensive scoring scheme is used generate compatible items for products such as fashion and furniture ensembles. The recommended ensembles 230 based on product, sales data, and other data should be well coordinated and provide greater user benefits and an improved retail experience. In one embodiment an extensive scoring scheme that does not require manual input can be used to consider a variety of factors before determining which products that will belong to the ensemble. Advantageously, using a large variety of factors allows for improved capture ‘brand language’ by using suitable weighing schemes. For example, instance, the described system can distinguish between products and brands that typically use an analogous color harmony scheme, while others may prefer higher contrast (complementary color), and respectively created color matched or color complementary product ensembles.

In some embodiments, ensemble generation can include a two-step process with link generation to score category associations and path generation to generate candidate ensembles. Link generation requires selection of a level of an ontology tree at which ensemble filtering is to be done. For instance if the taxonomy is:

women>clothing>outerwear>jackets_&_hoodies>down_jackets
this could be the third level in the taxonomy tree, which in this case, is outerwear. Remaining levels may be used for score modifications (i.e. boosting) in the scoring stage rather than filtering. This selection criterion can be based on custom heuristics and can be domain dependent.

Traffic-driven category association scores use a defined metric at the selected ontology level. The scores are quantized to ordinals in the range 0-5 where 0 indicates incompatible and 1, 2, 3, 4, 5 indicates varying degrees of compatibility.

In some embodiments, domain knowledge from experts can be used to generate human-curated links at the selected ontology level for compatible categories for outfit generation. Domain knowledge links identify two kinds of associations—compatible (with a integer range of 1-5) and incompatible (0). Associations can be provided at any level of the ontology tree. Parents with unspecified weights take the maximum of all their child-association pairs. Child nodes with unspecified split up the parents' score equally. The final edge weight between the categories is a weighted sum of the two types of scores with higher weight given to expert-generated links. Since 0-weight is used for filtering, the expert's score will override the noisier traffic-based score.

Generated links generated form a large graph, with categories as nodes and outfit associations as edges. When an outfit is to be served for a select source product a greedy (highest-weight first) depth-first walk can be made through compatible nodes and top-N disjoint ensemble sets generated. When a node is added to an ensemble, it should be checked for compatibility with (have a direct link to) every node in the current partial ensemble. For example, if a current ensemble is {women_top, women_skirt}, a women_t-shirt cannot be added to this ensemble since expert rules will place the association strength at 0. But women_loafers can be added since it will have no zero-links to any category in the ensemble.

After candidate ensembles are generated, products are selected for each category slot in the ensemble using a compound score from a number of visual and non-visual factors. Visual factors are based on image processing techniques that convert the retail product image into latent features that describe the color, pattern and shape in vector space. The high-dimensional descriptors are converted into lower dimension by an ensemble of simple models that score the image in each of the following factors. For each candidate ensemble, high ranking candidate products are selected based on their total score. Factors can include, but are not limited to:

Color compatibility—A color histogram of an apparel or furniture item pair can be used to generate color compatibility scores.

Temperature—A simple decision tree ensemble classifier is built using samples of colors labeled ‘warm’ and ‘cool’. Scores from the color temperature classifier are used to get the warmth of each color bin. The ‘warm’ score of an apparel furniture item is the computed using its color histogram by computing the weighted average of all the temperature scores of the color bins in the histogram. The score can be a continuous value ranging from 0 (cool) to 1 (warm). Temperature compatibility between two products is given by the absolute difference between warmth scores. The closer their warmth (or coolness when the scores are low) the higher the compatibility.

Harmony—The dominant color of the apparel or furniture item is first extracted from the color histogram. Three different kinds of color harmonies are then applied to search for colors that pair well with the given color.

Monochromatic—variations in the shade of the same color (hue) are chosen such as light and dark blue

Complementary—colors that are on the opposite side of the color wheel are chosen (high contrast) such as yellow and purple

Analogous—colors that are neighboring on the color wheel are chosen such as red and orange.

Pattern compatibility: A pattern vector derived from the raw image and indicating the presence or absence of a known pattern along with the color histogram is used to generate a pattern compatibility score.

Busyness—A simple classifier can use visual features to compute a score for how ‘busy’ the print is. Classifier to predict busyness of a garment is trained with manually labelled images. High dimensional visual features are extracted by processing the image histogram in perceptual color space. A non-linear Support Vector Classifier (SVC) with a radial basis function (rbf) kernel can be used to model these visual signals. The features are scaled to work best with gaussian kernel like rbf. The probability derived from the classifier is used as the busyness score of the garment. Busy prints are to be balanced out by plain prints. This component of the compatibility score tries to maximize the distance between the busy scores of the individual products.

Pattern Neutrality Boost—Some patterns like blue denims and black-white stripes can be considered as neutrals. These are identified and given additional score boosts.

Category compatibility: Category compatibility scores at the level below which ensembles were generated are used for scoring by this module. For instance, if the ensemble is generated using women>clothing>skirts and women>footwear>shoes but the specific pair of products under consideration are a-line skirts and pumps which happen to have a high rank in terms of category compatibility (traffic-based or curated links), this score is used to boost the more compatible products amongst higher-level categories that already pair well together.

Style compatibility: A simple decision-tree classifier using image features as well as metadata features such as fabric and product attributes can be trained to learn to discriminate between labeled styles (for e.g., hipster, preppy, retro, punk, prom, classic). In the case of furniture, style is replaced by themes such as minimalist, art-deco, contemporary. The style description has a value in the range [0,1] indicating the propensity of that product to the style (each product can belong to multiple styles). Style compatibility is higher if the styles vectors are closer in euclidean distance.

Occasion compatibility: A simple decision-tree classifier using image features as well as metadata features such as fabric and product attributes can be trained to learn to discriminate between labeled occasions (for e.g., day_casual, day_formal, evening_cocktail, beachwear). For furniture, occasion is equivalent to selected rooms such as patio, living_room etc. The occasion description has a value in the range [0,1] indicating the propensity of that product to the occasion (each product can belong to multiple occasion). Occasion compatibility is higher if the occasion vectors are closer in euclidean distance.

Brand compatibility: The brands of the products under consideration are scored for compatibility to better pairing. For instance, brands which have high brand co-occurrence products will pair well together in an ensemble. Scores can be used to generate affinity scores between brands.

Price compatibility: The price vector is a vector of numbers describing the price which includes absolute price, retail price, discount amount etc. This vector is standardized using z-scores for each price dimension within a specific category. The price compatibility score is the cosine similarity between the standardized price vector. Typically, high-priced products within a category will tend to have high similarity even if their absolute price values are widely different. So, if the user is viewing a luxury item from the pant category, a compatible luxury handbag might be recommended with it. As another example, if a user purchased a $100 formal jacket they be open to buying a $50 tie, but not the other way round.

Personalization Boost: Some candidate products in the ensemble are given a small personalization boost if they have seen recent engagement from the user or due to other factors which considered relevant for personalization. Additionally, the weights of each of the various compatibility scores can be tuned in a personalized manned using sensitivities from a personalization module. For instance, some users may prefer a monochromatic color harmony with brand compatibility as their ensemble of choice over others.

In some embodiments, association scores such as required for traffic-driven categorization, affinity scores for category or brand association, or other co-location or similarity scoring can use a pointwise mutual information (PMI) or normalized pointwise mutual information (NPMI) metric association measures. For example, NPMI can be used to identify semantic relationships between words in natural language processing tasks. Formally, PMI is the log of the ratio of the observed co-occurrence frequency to the frequency that is expected under independence. Strong associations have high PMI because the probability of co-occurrence is close to the probabilities of occurrence of each word. A PMI of zero means that the random variables are statistically independent, positive PMI means that they co-occur more frequently, and negative PMI means they co-occur less frequently than would be expected if they were independent. PMI can be defined as follows:

$$pmi ( x ; y ) = {log}_{2} ( \frac{p ( x , y )}{p ( x ) p ( y )} )$$

Maximum likelihood estimates of p(x)=C(x)/N and p(x,y)=C(x,y)/N where N is the number of samples in the dataset and C(x) is count of x occurring in the dataset as part of any pair and C(x,y) is the count of x co-occurring with y.

Since PMI is unbound, in order to force the values to the range [−1,+1], resulting in −1 for never occurring together, 0 for independence, and +1 for complete co-occurrence (perfect association). This is also expected to reduce some of the low frequency bias. NPMI can be defined as follows:

$$npmi ( x ; y ) = \frac{{log}_{2} ( \frac{p ( x , y )}{p ( x ) p ( y )} )}{- {log}_{2} p ( x , y )}$$

NPMI scores can be used for generating affinity scores to quantify the strength of category and brand associations which is used in deriving a scores. In practice, since NPMI exaggerates rare associations, upper and lower thresholds should typically be used to mine associations from the resulting scores. Additionally, since PMI obeys chain rule, it can be used to derive the association score between unseen pairs conditioned on a third common value (conditional PMI). This is very useful in deriving transitive relationships in the long tail.

As will be appreciated, alternative association measures for mining collocations can also be used. Instead of NPMI, Odds Ratio or Correlation measures such as Chi-Square can be employed. Other collocation measures with other required properties can be also be used.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Devices can have touch screens as well as other I/O components.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud computing environment” is an environment in which cloud computing is employed.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. A method for presenting related products to a user, the method comprising the steps of:
providing product association data derived at least partially from at least one of traffic-based links and expert curated links;
generating a product ensemble from the product association data;
compatibility scoring the generated product ensembles; and
recommending highly scored ensembles to a user.

2. The method of claim 1, wherein the step of compatibility scoring uses visual compatibility measures.

3. The method of claim 1, wherein the step of compatibility scoring uses non-visual compatibility measures.

4. The method of claim 1, wherein the step of compatibility scoring is based at least in part on pointwise mutual information techniques.

5. The method of claim 1, wherein the step of compatibility scoring is based at least in part on color compatibility.

6. The method of claim 1, wherein the step of compatibility scoring is based at least in part on pattern compatibility.

7. The method of claim 1, wherein the step of compatibility scoring is based at least in part on category compatibility.

8. The method of claim 1, wherein the step of compatibility scoring is based at least in part on style compatibility.

9. The method of claim 1, wherein the step of compatibility scoring is based at least in part on occasion compatibility.

10. The method of claim 1, wherein the step of compatibility scoring is based at least in part on brand compatibility.

11. The method of claim 1, wherein the step of compatibility scoring is based at least in part on price compatibility.

12. The method of claim 1, wherein the step of compatibility scoring is based at least in part on personalized scoring boost based on user data.

13. A system for presenting related products to a user, the system comprising:
a product association module able to provide data derived at least partially from at least one of traffic-based links and expert curated links and determine a product ensemble from the product association data;
a compatibility scoring module able to determine compatibility scores from the generated product ensembles of the product association module; and
a recommendation module for recommending highly scored ensembles to a user based on the determined compatibility scores.

14. The system of claim 13, wherein compatibility scoring uses visual compatibility measures.

15. The system of claim 13, wherein compatibility scoring uses non-visual compatibility measures.

16. The system of claim 13, wherein compatibility scoring is based at least in part on pointwise mutual information techniques.

17. The system of claim 13, wherein compatibility scoring is based at least in part on color compatibility or pattern compatibility.

18. The system of claim 13, wherein compatibility scoring is based at least in part on category compatibility, style compatibility, occasion compatibility, or brand compatibility.

19. The system of claim 13, wherein compatibility scoring is based at least in part on price compatibility.

20. The system of claim 13, wherein compatibility scoring is based at least in part on personalized scoring boost based on user data.
